(19) United States
(12) Patent Application Publication
(10) Pub. No.: US 2017/0226600 A1
(43) Pub. Date: Aug. 10, 2017

(54) PRESSURE RELIEF VALVE FOR PRESSURIZED FURNACE

(71) Applicant: Primetals Technologies Austria GmbH, Linz (AT)

(72) Inventors: Bernard GILL, Saltburn-by-the-Sea (GB); Gareth KAPS, Darlington (GB)

(21) Appl. No.: 15/514,574

(22) PCT Filed: Sep. 24, 2015
(86) PCT No.: PCT/EP2015/071988

§ 371 Date: Mar. 27, 2017

(30) Foreign Application Priority Data
Sep. 30, 2014 (GB) 1417287.8

(51) Int. Cl. C21B 7/00; F27D 21/00; F16K 1/20; F16K 17/10; F16K 17/168

(52) U.S. Cl. CPC C21B 7/005; F16K 17/10; F16K 17/168; F16K 1/2007; F27D 21/00; F27D 2021/0071

(57) ABSTRACT

A pressure relief valve system has a fluid outlet (1) from a pressure vessel; a flexible expansion piece (4) at an end of the fluid outlet remote from the pressure vessel; a primary pressure relief valve has a valve seat and a valve lid (7). The valve seat has a flange (5) mounted on the expansion piece and the valve lid forms a valve seal with the flange. A fluid off-take (13) is connected to the fluid outlet (1) and a secondary pressure relief valve (11) receives fluid from the fluid off-take. The secondary pressure relief valve has an outlet (12) coupled to a valve opening actuator (15), whereby passage of fluid through the secondary pressure relief valve (11) causes the opening actuator to operate to open the valve lid (7).

### CROSS-REFERENCE TO RELATED APPLICATIONS

The present application is a 35 U.S.C. §§371 national phase conversion of PCT/EP2015/071988, filed Sep. 24, 2015, which claims priority of United Kingdom Patent Application No. 1417287.8, filed Sep. 30, 2014, the contents of which are incorporated by reference herein. The PCT International Application was published in the English language.

### TECHNICAL FIELD

This invention relates to a pressure relief valve, such as a bleeder valve, in particular for use on a blast furnace.

### TECHNICAL BACKGROUND

Blast furnaces, and other pressure vessels, typically have pressure relief valves in case the pressure exceeds the design specification for that vessel. In a blast furnace, the pressure relief valves are typically at the top of the furnace and are connected to a duct from the furnace. When a pressure vessel is working at its designed pressure, it must be sealed in order to maintain that pressure. Should the pressure exceed the design pressure, then that pressure must be relieved to avoid a catastrophic burst. Large pressure vessels also require large bore outlets to relieve pressure build up quickly, and such outlets must have valves fitted to them to seal, or vent, as circumstances dictate.

Sealing or venting of large volumes of fluid through large bore vents is currently achieved using a design of relief or bleeder valves wherein a lid is forced open by a hydraulically, or pneumatically driven actuator, which require a power source to operate, or by weights acting under gravity onto a seal around the end of the vent pipe, which are heavy and bulky. Some of these designs are able to be opened fully with operator controlled mechanisms, while others simply oscillate without the means to fully open at the will of the plant operator. In the event of over-pressure and a failure of actuation, some designs allow for opening of the valve to a varying extent, usually by partial opening of a bleeder valve against springs. For a blast furnace, usually, there are at least three valves. A typical design relies on springs to keep a lid in place on a valve seat until the pressure is sufficient to overcome the force of the springs. In some cases, between the lid and seat, there may be soft seals. If the force is only just sufficient to crack open the valve seal in a device with soft seals, then hot gases may escape through the thin opening and melt the soft seals, so that when the pressure drops and the lid falls back again, the seal is no longer entirely effective.

WO2007090747 describes a bleeder valve for a pressurized furnace in which a closure member is mounted to a pivoting arm which is actuated by a hydraulic or pneumatic cylinder to open the valve. As this requires external power to be available to fully open the valve, there is a risk that it will fail to open in extreme circumstances, if power is lost to the hydraulic or pneumatic cylinders.

### SUMMARY OF THE INVENTION

In accordance with a first aspect of the present invention, a pressure relief valve system comprises a fluid outlet from a pressure vessel; a flexible expansion piece at an end of the fluid outlet remote from the pressure vessel; a primary pressure relief valve comprising a valve seat and a valve lid, wherein the valve seat comprises a flange mounted on the expansion piece; and wherein the valve lid is adapted to form a valve seal with the flange; a fluid off-take connected to the fluid outlet; a secondary pressure relief valve to receive fluid from the fluid off-take; the secondary pressure relief valve further comprising an outlet coupled to a valve opening actuator, whereby passage of fluid through the secondary pressure relief valve causes the opening actuator to operate to open the valve lid.

When pressure in the pressure vessel and hence the fluid outlet exceeds a threshold for the secondary pressure relief valve, the latter opens to allow the fluid through to cause an actuator to open the primary pressure relief valve on the pipe.

Preferably, the flexible expansion piece comprises a hollow body with concertinaed sides e.g. a bellows.

Preferably, the hollow body has a substantially cylindrical cross-section.

Preferably, the cross section is less than or equal to the cross-section of the fluid outlet.

Preferably, the lid is coupled to the opening actuator by an over-center linkage.

Preferably, the over-center linkage is coupled to the opening actuator by an operating lever.

Preferably, the system further comprises a controllable valve lid closure mechanism.

Preferably, the mechanism comprises a hydraulically or pneumatically controlled cylinder coupled to the lid.

Preferably, the cylinder is coupled to the lid by a pivotally mounted operating lever and an over-center linkage.

Preferably, the flange further comprises an O-ring seal.

Preferably, the fluid outlet and lid are mounted to a common support.

Preferably, the system further comprises a first stop and a second stop mounted to the common support in planes perpendicular to one another.

The stops are positioned such that opposite ends of the over-center linkage contact the stops, which may be horizontal and vertical stops.

In accordance with a second aspect of the present invention, a blast furnace pressure vessel comprises a plurality of pressure relief valve systems according to the first aspect.

In accordance with a third aspect of the present invention, a method of relieving pressure in a pressurized vessel comprising a fluid outlet and at least one primary pressure relief valve comprising a valve seat and a valve lid, the method comprising supplying fluid from the fluid outlet to a secondary pressure relief valve; detecting pressure of the fluid in the secondary pressure relief valve; when the detected pressure exceeds a predetermined threshold, opening the secondary pressure relief valve to permit the passage of the fluid to a valve opening actuator; causing a valve opening cylinder to move an operating lever and over-center linkage coupled to the valve lid, such that the valve lid opens.

### BRIEF DESCRIPTION OF THE DRAWINGS

An example of a bleeder valve in accordance with the present invention will now be described with reference to the accompanying drawings in which:

FIG. 1A is a perspective view of an example of a pressure relief valve according to the present invention, when open;

FIG. 1B is a perspective view of the example of a pressure relief valve according to the present invention, when closed;

FIG. 2A shows more detail of the pressure relief valve of FIGS. 1A and 1B;

FIG. 2B illustrates part of the mechanism for opening a pressure relief valve according to the present invention;

FIG. 3A illustrates an example of a pressure relief valve according to the present invention, in the process of opening;

FIG. 3B illustrates the pressure relief valve of FIG. 4A, when fully open;

FIG. 4A is a perspective view of the valve mechanism in other Figures in a manner exposing the valve mechanism without showing other elements of the pressure release valve;

FIG. 4B is the view from one side of the valve mechanism of FIG. 4A; and

FIG. 4C is a side view of the valve mechanism of FIG. 4A, in the direction of view of FIG. 2A.

### DESCRIPTION OF AN EMBODIMENT

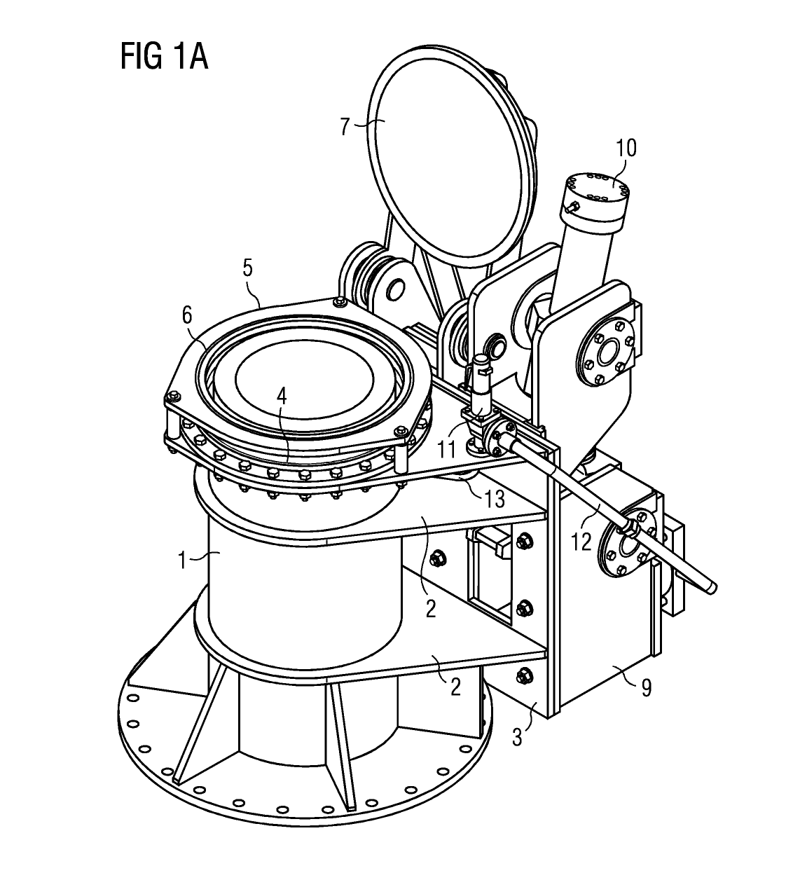

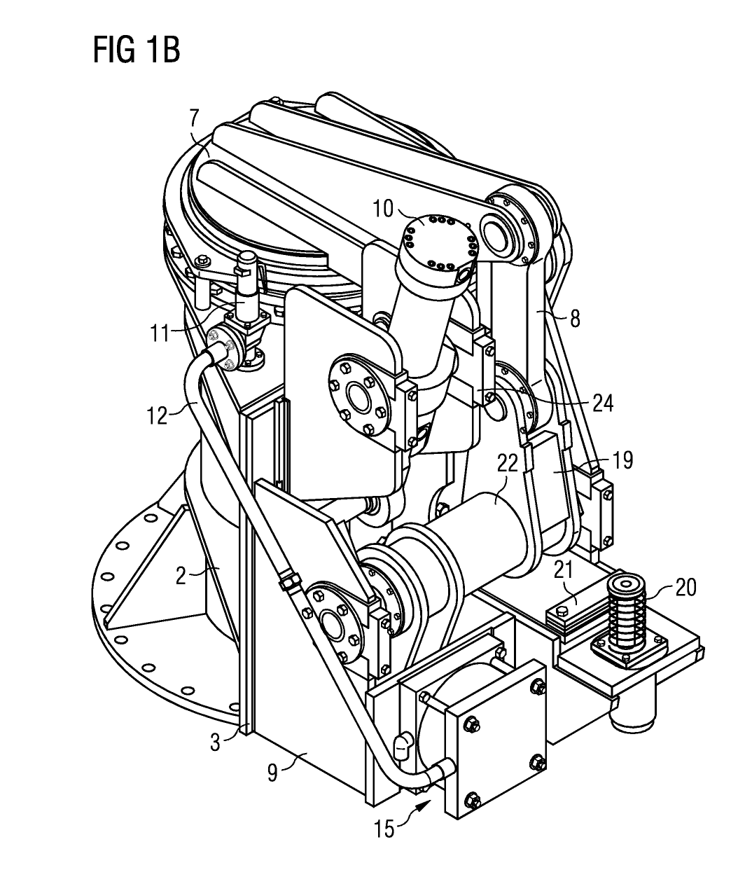

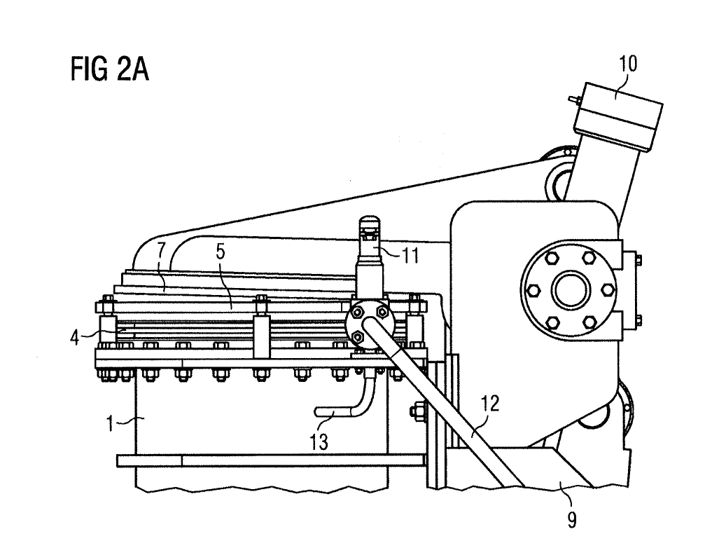

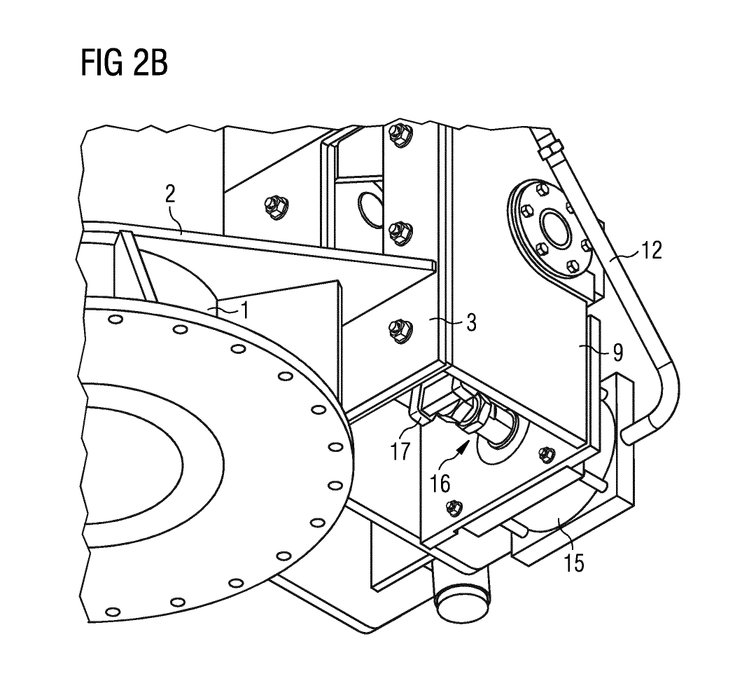

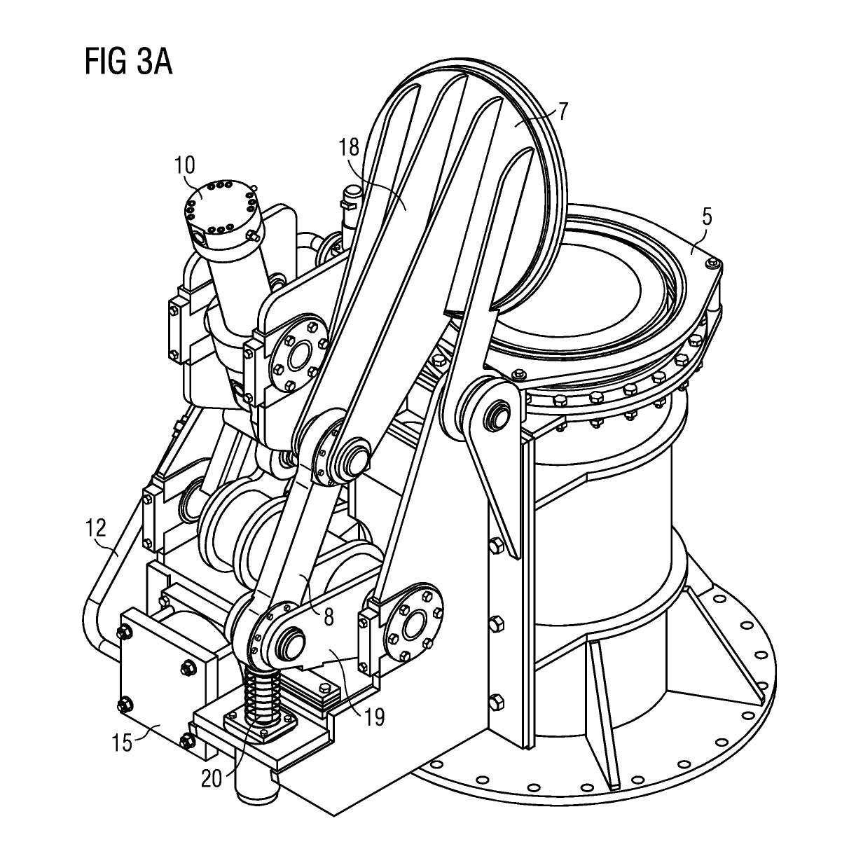

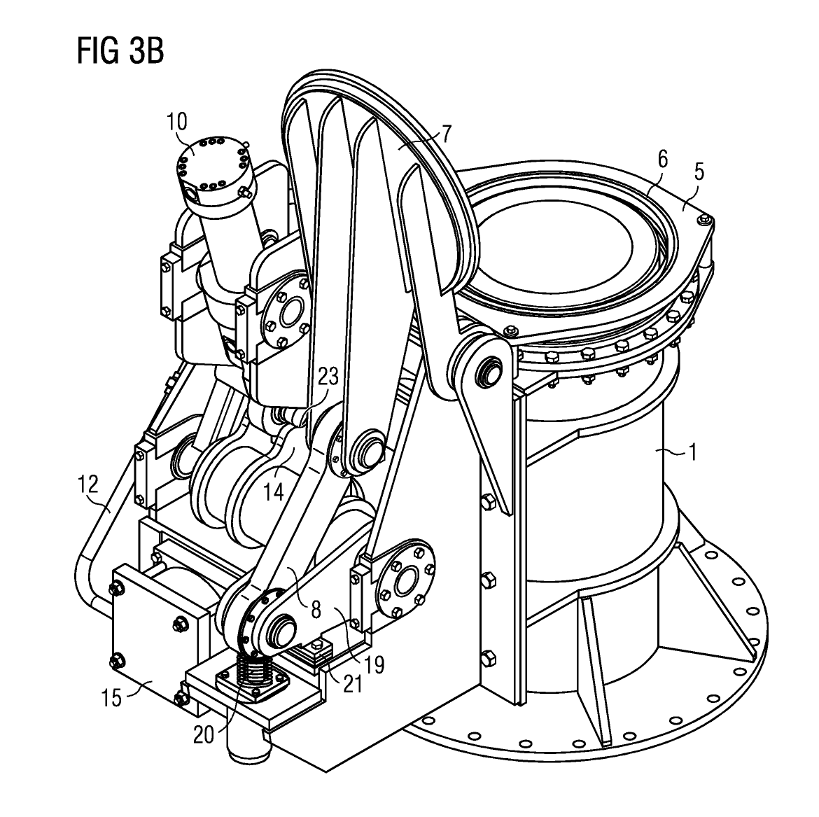

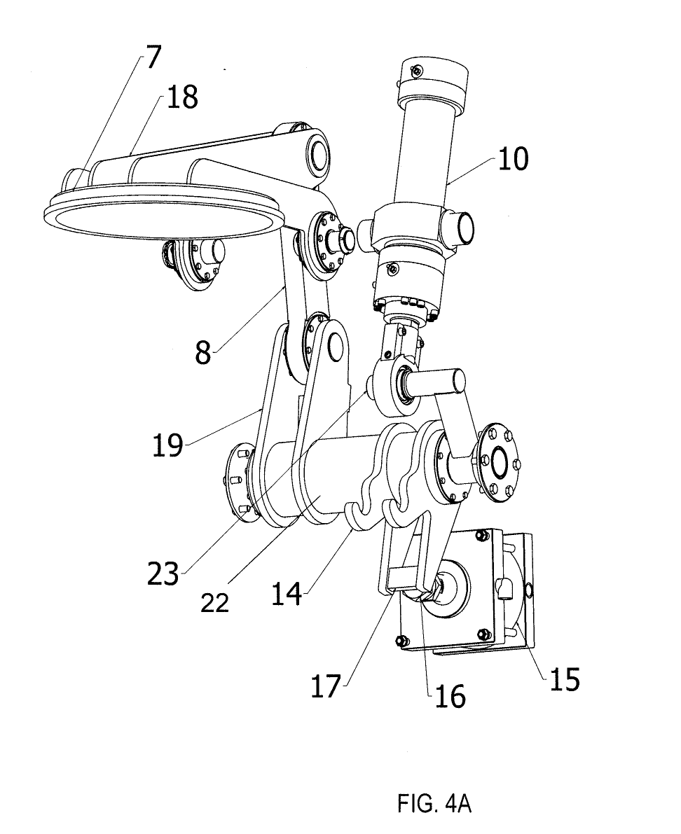

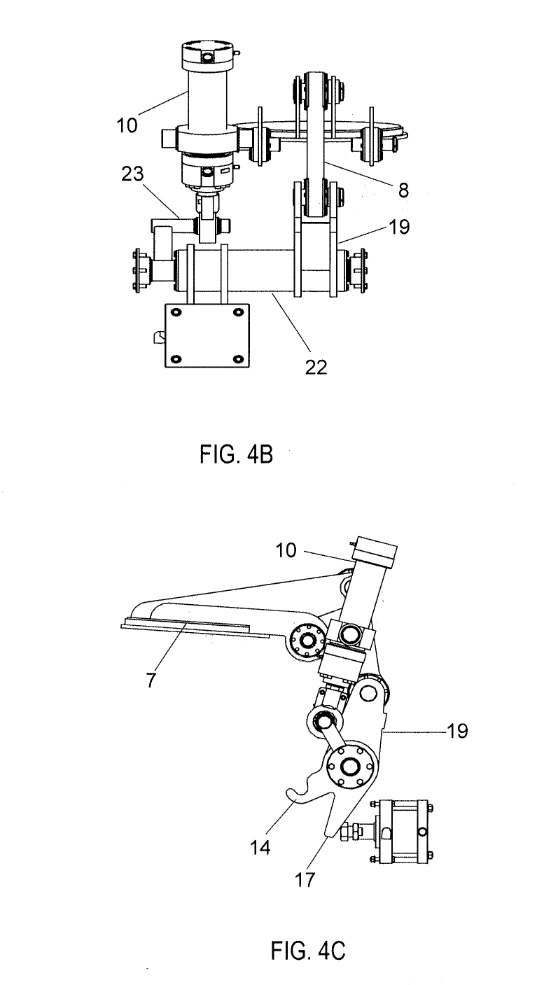

FIGS. 1A, 1B and 4A, 4B and 4C illustrate an example of a pressure relief valve system according to the invention. In FIG. 1A, the valve is open, in FIG. 1B, the valve is closed. FIGS. 2A and 4A, 4B and 4C show more detail of part of the system. The valve system comprises a large bore pipe 1 from a blast furnace pressure vessel (not shown), for example, of the order of 500 mm to 650 mm diameter, to which a valve operating mechanism is attached, supported on the pipe. A flexible bellows type expansion piece (bellows unit) 4 is provided at an end of the pipe 1 remote from the furnace, wherein the bellows unit 4 is mounted on an outer circumference of the pipe. A flat flange 5 and a seal 6, typically an O-ring seal for a cylindrical pipe and flange, are mounted on the bellows unit 4, and a lid 7 is coupled to the support 3. A pressure relief valve for the pipe and pressure vessel is formed by the flange 5 and lid 7. The flange and O-ring provide a contact surface for the lid 7. The lid is pivotally mounted by an over-center linkage 8 (FIGS. 1B, 3A and 4A) and an operating lever 19 (FIGS. 3A and 4A) to sidewalls 9 of the support 3. Once it is closed by an actuator, the nature of the linkage provides a ‘fixed’ position for the lid 7 which will largely not deflect under any pressure load. A port let into the pipe 1 is connected by a narrow bore pipe 13, for example, in the range of 10 mm to 50 mm, to a commercially available certified pressure relief valve 11 (FIG. 2A). The outlet of valve 11 is connected via a narrow bore pipe 12 to an actuator 15 and opening cylinder 16 (shown in FIGS. 2B and FIG. 4A). A closing cylinder 10 (FIG. 4A), typically hydraulically or pneumatically operated, and coupled via a rotatable cylinder 22 to the operating lever 19 and over-center linkage 8, is provided for closing the lid. A closure stop 24 and an opening stop 21 are provided for the over-center linkage 8, as well as a decelerator 20. The decelerator may be oil filled or gas filled.

Closure of the valve 11 depends upon operation of the hydraulic cylinder 10. When the bleeder valve 5, 7 is open, there is a gap between the hydraulic cylinder cross head 23 and a fitting 14 in which it sits (FIG. 3B). The operating lever 19, connected to the over-center linkage 8, is hard up against the horizontal mechanical stop 21. When the bleeder valve starts to close, the hydraulic cylinder 10 advances and the cross head 23 engages in the fitting 14 as can be seen in FIG. 3B. As the hydraulic cylinder 10 extends, the operating lever 19 and linkage 8 drive the bleeder valve lid 7 against the escaping gas flow. As the hydraulic cylinder 10 continues to extend, the operating lever and linkage approach the over-center position. The bleeder valve lid 7 comes into contact with the flange 5 and seal 6 and starts to compress the bellows unit 4. When the hydraulic cylinder 10 is fully extended, the linkage 8 is hard up against vertical mechanical stop 24. With the bleeder valve lid 7 closed, the bellows 4 is partially compressed and together with the internal gas pressure provides an opposing force to hold the over-center linkage 8 in the locked position. Due to the nature of a bellows arrangement under pressure, the higher the internal pressure, the greater the sealing force.

Once the valve has been closed, the hydraulic cylinder 10 is retracted out of the way, as it is not needed for bleeder valve opening, and disconnecting the drive mechanism from the valve lid in this way ensures the fastest operating response in the event of over-pressure. As the bleeder valve closing mechanism completes the closing process, the bleeder valve opening cylinder 16 is pushed back by an end piece or ‘shoe’ 17 of the valve closing mechanism into the body of the actuator 15. The control linkage which closes the bleeder valve lid 7 acts in the manner of an over-center clamp. The bleeder valve lid is closed when the lid is pressed against the seal 6 which is mounted in the flange 5. The flange may form part of bellows unit 4. The partial compression of the bellows unit causes a spring force reaction which pushes back against the lid 7 and locks the over-center linkage mechanism. The bleeder valve closing mechanism is typically hydraulically or pneumatically actuated, although other mechanical actuators could be used. With the lid closed and the hydraulic actuator retracted, the closed lid 7 and the control linkage 8 are locked in place. The bellows unit 4 may comprise a concertinaed sidewall with rigid end pieces forming a hollow body. Typically, the cross section of the hollow body is broadly similar to the cross section of the pipe on which it is mounted, so it is generally cylindrical, although other shapes are not excluded. As described above, the closing lid 7 partially compresses the bellows unit 4 and the spring reaction force pushes back against the lid to hold the linkage 8 in the over-center position. In addition, the vessel internal pressure is also pushing on the sealed underside of the lid 7 adding to the apparent opening force which, due to the bellows arrangement and over-center linkage, acts to increase the sealing force between the flange 5, seal 6 and lid 7. Thus, the lid is fixed in its closed position and is effectively a rigid body. The flexible bellows unit 4 pushes the flange 5 and seal 6 against the underside of the lid by virtue of its spring force, but also by the vessel internal pressure that is acting within the annular folds of the bellows. Thus the combined spring force and annular pressure in the bellows 4 provide a sealing force against the lid 7. As the vessel internal pressure rises, so does the force holding the lid closed and the sealing force against the lid.

Existing designs rely on an external force from gravity weights, or spring nests, or actuators acting through levers to maintain the closing force required between the valve cover and the valve seat. This force has to be set individually to provide enough sealing force to hold the valve closed and sealed, but not so much that it inhibits opening at the required pressure. This setting is often found by trial and error during commissioning. In the present invention, the bleeder valve closes the lid with sufficient force to overcome the gas flow and presses the lid 7 against the seal flange 5 to partially compress the bellows expansion piece 4. The compression creates a reaction spring force that seals the valve. The vessel internal pressure acting on the lid 7 provides an additional lid locking force that is exactly proportional to the vessel internal pressure. The vessel internal pressure acting within the bellows annular folds also provides an additional sealing force that is exactly proportional to the vessel internal pressure. Thus, the invention has the advantage that the bleeder valve lid has a self adjusting locking force and the seal has a self adjusting sealing force.

To satisfy the requirements of a safety valve, the valve must relieve pressure with full bore opening and also open without any external control system, or actuator. Thus, opening is achieved by supply air to the actuator 15. However, the valve may use external control, or power to open or close the valve, at other times. The valve opening mechanism includes the certified commercially available pressure relief valve 11 connected via the narrow bore pipe 12 to the actuator 15 and the opening cylinder 16. Rising internal pressure in the pipe 1 is detected by valve 11 in gas extracted through the off-take 13 on the pipe which feeds into the certified valve 11. When this pressure exceeds a pre-set limit, the valve 11 is triggered and opens to let gas pass into outlet pipe 12. The pressure of this gas in the actuator 15 causes the opening cylinder 16 to move out. The bleeder valve opening cylinder 16 is driven by the gas pressure from the pipe 1 and pushes on the back of an end piece 17 of the valve closing linkage. The relatively small bore port let into the pressurized vent pipe 1 below the bellows 4, provides a source of gas from the off-take 13 to the standard commercially available pressure relief valve 11 which is accurately calibrated to the required threshold pressure. The relief side of the pressure relief valve 11 is piped 12 up to an appropriately sized valve opening actuator 15, 16 that is positioned to push against the reverse side 17 of the valve closing linkage.

As the end piece 17 moves, it rotates the main lever 22 (FIG. 4A) and drives operating lever 19 and linkage 8 back through the over-center position, breaking the valve lid seal, allowing the self weight of the mechanism and the gas blast on the bleeder valve lid to combine to unlock the over-center linkage and open the valve fully, as can be seen in FIGS. 3A and 3B. As the bleeder valve lid 7 opens, the high pressure dead head inside the pipe 1 changes to a high velocity, low pressure region causing the certified safety valve 11 to close normally and prevent the passage of “dirty” gas through the off-take 13 and outlet pipe 12. The operating lever 19 and linkage 8 fall back as the lid moves towards full opening and the linkage is controlled by a decelerator 20, which prevents a sudden impact on reaching the fully open position. The bleeder valve 5, 7 is fully open when the operating linkage 8, 19 is hard against the horizontal mechanical stop 21. The vessel internal pressure is able to blow the valve lid 7 open. Whatever the level of pressure holding the valve closed, that same level of pressure is used via the mechanism to open it. If the valve is operated on request from the control system, then there may not be sufficient pressure to blow the lid fully open in which case the weight of the linkage 8 will act under gravity and open the lid fully to bring the sealing face of the lid 7 away from the damaging effects of the fluid escaping from the vessel.

Some existing designs that employ a closing mechanism use an actuator that not only closes the valve lid, but also brings a spring nest into an over-center position to lock the valve closed. The actuator is left in position, but dormant, although the actuator can be re-actuated to open the valve, or when the vessel internal pressure overcomes the spring nest and unlocks the over-center mechanism, then the actuator acts as a damper that slows down the opening of the valve and causes prolonged exposure of the lid to the damaging action of the fluid stream escaping from the vessel.

The bleeder valve lid of the present invention is closed by a hydraulic cylinder 10 (FIG. 4A) which operates a linkage 8 that goes over-center as the lid 7 presses down on a flexible bellows type expansion piece 4. The spring force of the bellows type expansion piece 4 provides the initial locking force for the over-center clamping. When the lid 7 is closed, the hydraulic cylinder 10 can be retracted (not shown) leaving the linkage 8 in its locked position. When the linkage is unlocked, the valve lid 7 is free to open without hindrance until the linkage contacts the decelerator 20 by which time the valve lid 7 is no longer exposed to the damaging action of the fluid stream escaping the vessel.

Thus, the invention has the advantage that the bleeder valve lid opens without restriction and drastically reduces the exposure of the lid sealing face to the damaging effects of the fluid escaping from the vessel.

Existing designs of a bleeder valve that can be opened on command do so by using the actuator that closed them. In the event of a power failure, or control system damage, then such valves have to rely on a spring nest to give way sufficiently to allow the valve to open at least partially.

In the present invention, the bleeder valve opens using the same opening mechanism, whether commanded to open by a control system, or using the built in self-actuating mechanism in the event of excess pressure occurring. In the event of a power failure or control system damage the valve cannot be opened on command. Instead, pressure of the gas from inside the pressure vessel vent 13 which passes through a standard safety valve, set to the desired pressure, and into an actuating cylinder 16 operates the actuating cylinder and opens the lid 7, so ensuring that the bleeder valve will work even if there is no external power source. The opening cylinder 16 (FIG. 4A) extends and pushes against the shoe 17 and hence the operating lever 19 and valve closing linkage 8 in such a way as to unlock the mechanism and allow the valve lid 7 to be blown open. An electro/mechanical valve (not shown) may be placed in parallel with the safety valve 11 to let fluid into the actuator 16 from the pressure vessel vent, under normal operating conditions.

The advantage is that because the sealing force is proportional to the vessel internal pressure and the lid locking force is proportional to the vessel internal pressure, then there will always be sufficient pressure available from the pressure vessel to ensure effective sealing and also to self operate the opening actuator.

The present invention provides a compact bleeder valve in which the opening mechanism is able to operate independent of any external power supply, using only the pressure of gas in the valve itself. The cylinder actuator must be powered, typically hydraulically or pneumatically actuated, in order to close the valve, but no external power is required to open the valve. If a hydraulic or pneumatic pressure failure occurs, the valves are still capable of opening against the over-center spring compression and expansion system and the valve then opens fully in the event of extreme furnace pressure, to provide a true safety pressure relief device. The valve of the present invention is able to operate as a safety valve, which is not possible with prior art designs. The pressure sensitive bleeder valve is controllable to a degree of accuracy not possible with existing designs. The bleeder valve may be opened or closed under the control of the plant operator, but also opens automatically if a threshold pressure is reached. For automatic opening, the bleeder valve makes use of pressure within the pressure vessel to actuate the opening mechanism, thus ensuring that the bleeder valve is capable of opening fully, even in the event of a control failure.

1. A pressure relief valve system for a pressure vessel, the system comprising:
a pressure vessel;
a fluid outlet from the pressure vessel; a flexible expansion piece at an end of the fluid outlet remote from the pressure vessel;
a primary pressure relief valve comprising a valve seat and a valve lid, the valve seat comprising a flange mounted on the flexible expansion piece; and the valve lid is configured to form a valve seal with the flange; and
a fluid off-take connected to the fluid outlet; a secondary pressure relief valve to receive fluid from the fluid off-take; the secondary pressure relief valve further comprising an outlet coupled to a valve opening actuator, whereby passage of fluid through the secondary pressure relief valve causes the valve opening actuator to operate to open the valve lid.

2. A system according to claim 1, wherein the flexible expansion piece comprises a hollow body with concertinaed sides.

3. A system according to claim 2, wherein the hollow body has a substantially cylindrical cross-section.

4. A system according to claim 3, wherein the cross section of the hollow body is less than or equal to the cross-section of the fluid outlet.

5. A system according to any preceding claim, wherein the lid is coupled to the opening actuator by an over-center linkage and the linkage being for selectively moving the lid to form the valve seal or to open the lid after the over-center linkage passes over-center.

6. A system according to claim 5, further comprising:
an operating lever coupling the over-center linkage to the opening actuator.

7. A system according to claim 1, further comprises a controllable valve lid closure mechanism.

8. A system according to claim 7, wherein the closure mechanism comprises a hydraulically or pneumatically controlled cylinder coupled to the lid and configured for operating the lid to open or close.

9. A system according to claim 6, further comprising a pivotally mounted operating lever and over-center linkage configured for coupling the cylinder to the lid.

10. A system according to claim 1, wherein the flange further comprises an O-ring seal.

11. A system according to claim 1, wherein the fluid outlet and the lid are mounted to a common support.

12. A system according to claim 11, further comprising a first stop and a second stop mounted to the common support in planes perpendicular to one another.

13. A blast furnace pressure vessel comprising a plurality of the pressure relief valve system according to claim 1.

14. A method of relieving pressure in a pressurized vessel, wherein the vessel comprises a fluid outlet and at least one primary pressure relief valve comprising a valve seat and a valve lid; and
the method comprising supplying fluid from the fluid outlet to a secondary pressure relief valve; detecting pressure of the fluid in the secondary pressure relief valve; when the detected pressure exceeds a predetermined threshold, opening the secondary pressure relief valve to permit the passage of the fluid to a valve opening actuator, for causing a valve opening cylinder to move an operating lever, and an over-center linkage coupled between the operating lever and the valve lid, such that the valve lid opens upon a movement of the operating lever.
